(19) United States
(12) Patent Application Publication
(10) Pub. No.: US 2014/0055674 A1
(43) Pub. Date: Feb. 27, 2014

(54) DISPLAY CONTROL DEVICE, INTEGRATED CIRCUIT, DISPLAY CONTROL METHOD, AND PROGRAM

(71) Applicants: Kotaro Sakata, Tokyo (JP); Shigenori Maeda, Kyoto (JP); Masaki Yamauchi, Osaka (JP)

(72) Inventors: Kotaro Sakata, Tokyo (JP); Shigenori Maeda, Kyoto (JP); Masaki Yamauchi, Osaka (JP)

(73) Assignee: PANASONIC CORPORATION, Osaka (JP)

(21) Appl. No.: 13/824,059

(22) PCT Filed: Sep. 26, 2012
(86) PCT No.: PCT/JP2012/006117

§ 371 Date: Mar. 15, 2013

(30) Foreign Application Priority Data
Oct. 19, 2011 (JP) 2011-229826

(51) Int. Cl. H04N 5/445

(52) U.S. Cl. CPC H04N 5/445
USPC 348/564

(57) ABSTRACT

A display control device according to an aspect of the present disclosure performs processing using (a) a main content item to be displayed by a display unit and (b) display elements arranged in a chain from which the main content item is selected. The display control device includes the following units. An importance calculation unit obtains additional information to be notified to a user and calculates an importance of the additional information. A relevance calculation unit calculates a relevance between the additional information and the main content item. A position determination unit determines a position to which the additional information is to be inserted in the display elements, based on the calculated importance and the calculated relevance. The position determination unit determines the position to receive more attention from the user as the importance and the relevance of the additional information are higher.

### TECHNICAL FIELD

The present disclosure relates to display control devices that control notifying from a device network group and displaying various advertisements and the like on a screen, in addition to processing for AV content items such as broadcast content items and video content items on a web.

### BACKGROUND ART

Conventionally, for display control devices, techniques of easily switching various kinds of broadcasting, such as terrestrial broadcasting, broadcasting satellite (BS), and communication satellite (CS), by using a remote controller (see Patent Literature 1 below) and techniques of achieving seamless move between a broadcast content item and a web content item (see Patent Literature 2) have been known.

### CITATION LIST

### Patent Literature

[PTL 1] Japanese Patent No. 3997980
[PTL 2] Japanese Patent No. 4052802

### SUMMARY OF INVENTION

### Technical Problem

However, the above-described conventional structures lack continuity between selecting (zapping) of a content item and a process, such as notification and operation, which is performed by as other various devices. In other words, there is a problem that selecting (zapping) of a content item by a user is separated, as a different phase, from the process, such as notification and operation, which is performed by various other devices.

In order to solve the above problems, the present disclosure provides a display control device allowing a user to select or operate various content items and check additional information without a particular conscious to differences of these various kinds of processes.

### Solution to Problem

In accordance with an aspect of the present disclosure for achieving the object, there is provided a display control device that performs processing using a main content item and a plurality of display elements, the main content item being to be displayed by a display unit, the display elements being arranged in a chain from which the main content item is selected, the display control device comprising: an importance calculation unit configured to obtain additional information and calculate an importance of the additional information, the additional information being information to be notified to a user; a relevance calculation unit configured to calculate a relevance between the additional information and the main content item; and a position determination unit configured to determine a position based on the importance calculated by the importance calculation unit and the relevance calculated by the relevance calculation unit, the position being a location to which the additional information is to be inserted in the display elements, wherein the position determination unit is configured to determine the position to receive more attention from the user as the importance and the relevance of the additional information are higher.

The general and specific aspect may be implemented as a method, an integrated circuit, a computer program, and a computer-readable recording medium, such as a Compact Disc-Read Only Memory (CD-ROM), and may be implemented also as a desired combination of them.

### Advantageous Effects of Invention

The display control device according to the present disclosure is capable of notifying information in consideration of an importance of the information and a relevance to a main content item. The display control device therefore allows a user to seamlessly perform selection and operation of various content items without a particular conscious to differences of these various kinds of processes.

### BRIEF DESCRIPTION OF DRAWINGS

FIG. 1 is a block diagram showing a functional structure of a display control device according to Embodiment 1.

FIG. 2 is a flowchart of display control processing according to Embodiment 1.

FIG. 3A is a diagram for explaining an example of information presentation according to Embodiment 1.

FIG. 3B is a diagram for explaining another example of the information presentation according to Embodiment 1.

FIG. 4 is a diagram for explaining a move of each thumbnail image.

FIG. 5 is a diagram for explaining processing for determining an insertion position of additional information in the display control processing.

FIG. 6 is a block diagram showing a functional structure of a display control device according to a variation of Embodiment 1.

FIG. 7 is a flowchart of display control processing A according to the variation of Embodiment 1.

FIG. 8 is a diagram for explaining processing for determining an insertion position of additional information in the display control processing A.

FIG. 9A is a diagram for explaining another example of the information presentation.

FIG. 9B is a diagram for explaining still another example of the information presentation.

FIG. 9C is a diagram for explaining still another example of the information presentation.

FIG. 10 is a diagram for explaining still another example of the information presentation.

FIG. 11 is a diagram for explaining a display example of thumbnail images.

FIG. 12 is a block diagram showing a functional structure of a display control device having a selection unit.

### DESCRIPTION OF EMBODIMENTS

### Observation Based on which Present Disclosure is Conceived

The inventors of the present disclosure found the following problems in the display control devices disclosed in “Background Art”.

With the developments of fusion between broadcasting and communications, television sets have various possibilities of being widely applied to new uses, for example, to browse web information, not only to merely watch broadcast content items. One of such new functions of television sets is proposed to notify various kinds of information relating to life at appropriate times.

In recent years, network functions among electrical devices are widely used. It is possible that a Blu-ray Disc (BD) recorder and a network camera are cooperated with a television set in order to operate a plurality of devices using a single remote controller or to check images captured by the network camera on a screen of the television set.

Furthermore, if home appliances, such as a washing machine, a refrigerator, and a microwave, in addition to these devices are cooperated with the television set, a user can check pieces of information of these appliances and devices, such as their operation states, on the television set. In other words, if a display device such as a television set is cooperated with other appliances/devices via a network to enable the display device to display pieces of information obtained from these appliances/devices, the user can refer to these pieces of information on the display device without going to the appliances/devices.

The technique disclosed in Patent Literature 1 switches channels according to an operation input of an upward operator and a downward operator of a cross key, for example. In addition, broadcast wave (tuner) is switched according to operation inputs of a rightward operator and a leftward operator. It is thereby possible to zap over other broadcast waves by operation using a single related operation means.

The technique disclosed in Patent Literature 2 displays two different kinds of services on a menu. A Graphical User Interface (GUI) in the technique disclosed in Patent Literature 2 shows icons which the user can select to filter or select received data. The GUI also shows a scroll chicka region and a video region. The scroll chicka region provides information regarding a Direct Broadcast Satellite System (DSS) event scheduled to occur in the near future, and an access to a related Internet website. The video region is a thinning region for displaying a size-decreased DSS program which is currently broadcast.

However, although the structures disclosed in Patent Literature 1 and 2 achieve a seamless move between kinds of broadcasting or between a broadcasting content item and a web content item, the structures lack a continuity between selecting (zapping) of a content item and a process, such as notification and operation, which is performed by other various devices. In other words, there is a problem that selecting (zapping) of a content by a user is separated, as a different phase, from the process, such as notification and as) operation, which is performed by various other devices. Notification from various other devices and push notification such as advertisements are often performed while a user is watching a content item. There is a possibility that the notification or push notification such as advertisements prevents the user from watching the content item and makes the user uncomfortable. Furthermore, as the number of devices connected to a network is increased, more various pieces of additional information are to be displayed on a display device. The additional information is information to be notified to the user. However, if a large number of pieces of additional information are displayed on a display device, there is a problem that a user misses the important information.

In accordance with an aspect of the present disclosure to solve the above-described problem, there is provided a display control device that performs processing using a main content item and a plurality of display elements, the main content item being to be displayed by a display unit, the display elements being arranged in a chain from which the main content item is selected, the display control device comprising: an importance calculation unit configured to obtain additional information and calculate an importance of the additional information, the additional information being information to be notified to a user; a relevance calculation unit configured to calculate a relevance between the additional information and the main content item; and a position determination unit configured to determine a position based on the importance calculated by the importance calculation unit and the relevance calculated by the relevance calculation unit, the position being a location to which the additional information is to be inserted in the display elements, wherein the position determination unit is configured to determine the position to receive more attention from the user as the importance and the relevance of the additional information are higher.

With this structure, the position determination unit determines a position to which additional information is inserted in a plurality of display elements, based on the importance of the additional information and the relevance to the main content item. As a result, it is possible to notify the additional information in consideration of the importance of the additional information and the relevance to the main content item.

As a result, a user can seamlessly perform selection or operation of various kinds of content items without any particular conscious to differences of the various kinds of the content items.

Furthermore, additional information having a higher importance receives more attention from the user. It is therefore possible to reduce a possibility that the user misses the important additional information.

It is also possible that the display control device further includes an insertion allowability calculation unit configured to calculate an insertion allowability based on a past selection frequency of the additional information, the insertion allowability indicating an allowability of inserting the additional information to the display elements, the past selection frequency indicating a frequency of selecting the additional information in a switching operation for switching the main content, wherein the position determination unit is configured to determine the position to which the additional information is to be inserted in the display elements, based on the insertion allowability calculated by the insertion allowability calculation unit, the importance, and the relevance.

This structure can increase or decrease pieces of additional information to be inserted in the display elements based on a user's past selection frequency to be adjusted to a user's preference.

It is further possible that the display control device further includes a display unit configured to display the display elements and the additional information inserted at the position determined by the position determination unit, wherein the position determination unit is configured to calculate an insertion priority to be higher as the importance and the relevance of the additional information are higher, and determine the position to receive more attention from the user as the calculated insertion priority of the additional information is higher.

It is still further possible that the position determination unit is configured to determine the position to be closer to center of a screen of the display unit as the calculated insertion priority of the additional information is higher, the position being in a region for displaying the in additional information in the display unit.

This structure allows the user to easily notice additional information having a high insertion priority.

It is still further possible that a category of the additional information is advertisements.

With this structure, for example, if the main content item is a drama, advertisements regarding a cast in the drama or advertisements of a product used in the drama can be displayed as additional information. As a result, it is possible to enhance appeal to the user.

It is still further possible that the importance calculation unit is configured to calculate the importance of the additional information to be higher as an advertisement fee of the advertisements is higher.

This structure allows advertisement having a higher advertisement fee to be displayed on a position receiving more attention from the user.

It is still further possible that the display control device communicates with an electrical device, and a category of the additional information is notification from the electrical device.

With this structure, for example, even if the main content item is a drama, it is possible to display a notification form an electrical device. As a result, for example, if the electrical device is a microwave, the user can easily notice a display such as “Heating is completed” during watching the drama and does not forget to take foods out from the microwave.

It is still further possible that the importance calculation unit is configured to calculate the importance of the additional information to be higher as a time duration from a current time to a notification deadline of the additional information is shorter.

This structure allows additional information having a shorter notification deadline to be displayed on a position receiving more attention from the user. The notification deadline is, for example, a time until which the device can wait an operation from the user. A shorter notification deadline requires a faster response from the user. In other words, additional information requiring a faster response from the user is displayed on a position receiving more attention from the user. As a result, it is possible to reduce the possibility that the user misses the additional information.

It is still further possible that the display control device communicates with an electrical device, and a category of the additional information is a power amount of the electrical device.

This structure allows the user to easily notice a power amount of the electrical device. As a result, for example, it is possible that the user checks a power amount indicated by the additional information and instructs the electrical device to reduce power consumption according to the checking results to eventually save energy.

It is still further possible that the importance calculation unit is configured to calculate the importance of the additional information to be higher as a power amount consumed by the electrical device is closer to a power amount supplied to the electrical device.

This structure allows additional information of an electrical device in which a power consumption is nearly a supplied power amount to be displayed on a position receiving more attention from the user. Therefore, before the power consumption is equal to the supplied power amount, the user can easily notice the additional information of the electrical device. As a result, the user can instruct the electrical device to reduce a power consumption, and it is possible to prevent a trouble caused when the power consumption is equal to the supplied power amount.

It is still further possible that the additional information is associated with a recommender who recommends the additional information, and the importance calculation unit is configured to calculate the importance of the additional information to be higher as a rank order of the recommender associated with the additional information is higher.

This structure allows additional information in a higher rank order of a recommender to be displayed on a position receiving more attention from the user.

It is still further possible that the rank order of the recommender is higher as the recommender receives more votes from viewers in a predetermined range.

This structure allows additional information associated with a recommender receiving more votes from viewers in a predetermined range to be displayed on a position receiving more attention from the user. For example, if the predetermined range is regarding viewers having a preference similar to the user's preference, additional information that is more similar to the user's preference is displayed on a position receiving more attention from the user.

It is still further possible that the display control device further includes a selection unit configured to select, according to user's instruction, one from among the display elements and the additional information as the main content item to be displayed by the display unit.

This structure allows the user to instruct to switch the main content item to be displayed on the display unit.

The above general and specific aspect may be implemented as a method, an integrated circuit, a computer program, and a computer-readable recording medium, such as a Compact Disc-Read Only Memory (CD-ROM), and may be implemented also as a desired combination of them.

The following describes embodiments in detail with reference to the drawings.

It should be noted that all the embodiments described below are general and specific examples of the present disclosure. Numerical values, shapes, materials, constituent elements, arrangement positions and the connection configuration of the constituent elements, steps, the order of the steps, and the like described in the following embodiments are merely examples. They are therefore not intended to limit the present disclosure. Furthermore, among the constituent elements in the following embodiments, constituent elements that are not described in independent claims that show the most generic concept of the present disclosure are described as elements constituting more desirable configurations.

Moreover, in the following description, the same reference numerals are assigned to identical structural elements. The identical structural elements share the same name and same function. Therefore, such identical structural elements are sometimes not described repeatedly.

### Embodiment 1

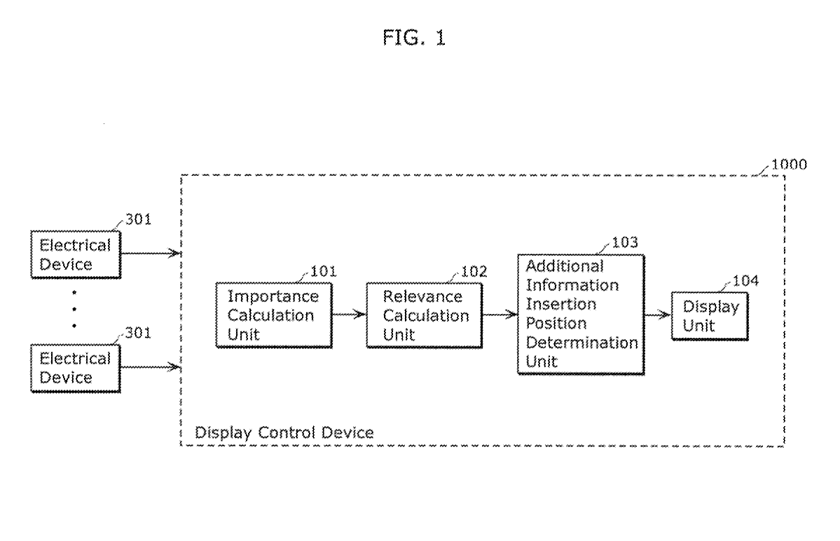

FIG. 1 is a block diagram showing a functional structure of a display control device 1000 according to Embodiment 1. The display control device 1000 is controlled by a remote controller (not shown) operated by a user.

The display control device 1000 communicates with one or more electrical devices 301 (external devices). More specifically, as shown in FIG. 1, the display control device 1000 is connected to one or more electrical devices 301 via a network. The network is a wired network using a LAN cable or the like, or a wireless network using a wireless LAN.

The electrical device 301 is a network home appliance such as a washing machine, a refrigerator, an air conditioner, an air purification system, a microwave, or a BD recorder. The electrical device 301 notifies additional information to the display control device 1000 via the network.

As shown in FIG. 1, the display control device 1000 includes an importance calculation unit 101, a relevance calculation unit 102, an additional information insertion position determination unit 103, and a display unit 104. More specifically, the display control device 1000 is a display control device that performs processing using (a) a main content item to be displayed by the display unit 104 and (b) a plurality of display elements which are arranged in a chain (referred to also as a “sequence” or a “line”) and from which the main content item is selected. The importance calculation unit 101 obtains a piece of additional information that is information to be notified to the user and calculates an importance of the obtained piece of additional information. The relevance calculation unit 102 calculates a as relevance between the piece of additional information and the main content item. The additional information insertion position determination unit 103 determines a position to which the piece of additional information is to be inserted among the plurality of the display elements, based on the calculated importance and the calculated relevance. The additional information insertion position determination unit 103 determines a piece of additional information having a higher importance and a higher relevance to be located at a position receiving more attention from the user. Here, the additional information insertion position determination unit 103 is an example of the position determination unit in the present disclosure.

The display control device 1000 receives video content items (hereinafter, referred to also as “content items”), such as broadcast content items, Video On Demand (VOD) content items, and Web video content items.

The importance calculation unit 101 receives pieces of additional information, and calculates an importance of each of the received pieces of additional information, which will be described in more detail later. A piece of additional information is information to be notified to the user. A piece of additional information is displayed by the display unit 104. A piece of additional information belongs to one of a plurality of categories. The plurality of categories are, for example, categories for various kinds of information, such as a advertisement category, a device notification category, and a power amount category.

The advertisements are notification from a distribution source of a content item received by the display control device 1000. A piece of additional information belonging to the advertisement category is, for example, information of a new product.

The device notification is notification from the electrical device 301 communicating with the display control device 1000. A piece of additional information belonging to the device notification category is, for example, a message “Washing and drying are completed.”

The power amount is, for example, a power consumption of the electrical device 301. A piece of additional information belonging to the power amount category indicates a power consumption of the electrical device 301. The electrical device 301 receives power from a power source (not shown).

From the electrical device 301, the display control device 1000 receives a piece of additional information belonging to the device notification category and a piece of additional information belonging to the power consumption category.

The relevance calculation unit 102 calculates a relevance between a piece of additional information and a main content item, which will be described in more detail later.

The additional information insertion position determination unit 103 determines a position to which the piece of additional information is inserted among the plurality of display elements, base on the calculated importance and the calculated relevance. The display elements are thumbnail images described later.

The display unit 104 is, for example, a Liquid Crystal Display (LCD). The display unit 104 displays images. The display unit 104 has a screen on which images are displayed. Hereinafter, the screen of the display unit 104 is referred to also simply as a “screen”.

The screen of the display unit 104 has a main region and a sub region. The sub region displays a plurality of display elements in which pieces of additional information are inserted. The main region displays a display element or a piece of additional information which is selected by a user from among the display elements and the pieces of additional information which are displayed on the sub region. In other words, according to user's selection, one of the display elements and the pieces of additional information which are displayed on the sub region is displayed on the main region.

Here, the above-described main content item is a content item displayed on the main region to be associated with the display element or piece of additional information which is selected by the user from among the display elements and the pieces of additional information which are displayed on the sub region.

It should be noted that the display unit 104 is not limited to a LCD. The display unit 104 may be a Plasma Display Panel (PDP) or an Organic Light Emitting Display (OLED). The display unit 104 may be implemented to a structure that forms images on a wall by using projection equipment or the like.

Next, the processing performed by the display control device 1000 (hereinafter, referred to also as “display control processing”) is described.

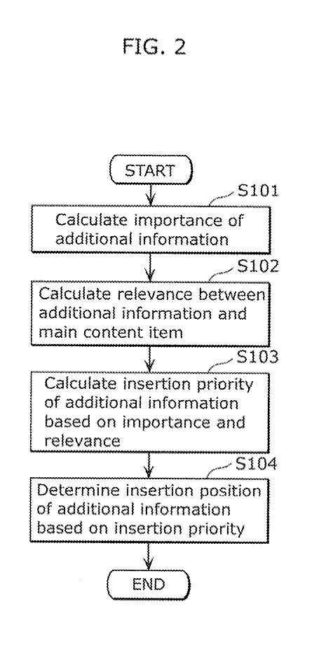

FIG. 2 is a flowchart of the display control processing. It is assumed that the display unit 104 displays a main content item.

First, the importance calculation unit 101 calculates an importance of a piece of additional information, which will be described in more detail later (S101). Next, the relevance calculation unit 102 calculates a relevance between the piece of additional information and the main content item displayed by the display unit 104 (S102). Then, the additional information insertion position determination unit 103 calculates (determines) an insertion priority of the piece of additional information, based on the importance and the relevance (S103). The processing from Step S101 to Step S103 is performed for each of pieces of additional information.

More specifically, at the step (S101) for calculating an importance of a piece of additional information, the importance calculation unit 101 receives pieces of additional information transmitted from the electrical device(s) 301 and distribution sources of content items, and calculates an importance of each of the received pieces of additional information.

Here, for example, in the case of a piece of additional information belonging to the advertisement category, the importance calculation unit 101 calculates an importance of the piece of additional information, so that the importance is higher as the piece of additional information indicates a higher advertisement fee. In the case of a piece of additional information belonging to the device notification category, for example, the importance calculation unit 101 calculates an importance of the piece of additional information, so that the importance is higher as the piece of additional information indicates a shorter notification deadline from a current time.

Next, at the step (S102) for calculating a relevance, the relevance calculation unit 102 calculates a relevance between the piece of additional information received by the importance calculation unit 101 and the main content item.

Here, for example, in the case of a piece of additional information belonging to the advertisement category, the relevance calculation unit 102 calculates a relevance calculation of the piece of additional information, so that the relevance is higher as the relevance between the piece of additional information and the main content item is higher. More specifically, if the main content item is a drama, a piece of additional information regarding advertisements or the like of a product used in the drama or a stage in which an actor or actress in the drama appears has a higher relevance.

The relevance corresponds, for example, to a degree of similarity between meta data of the main content item and meta data of a piece of additional information belonging to the advertisement category, and a degree of matching between a text of the main content item and a text of the piece of additional information.

Subsequently, the additional information insertion position determination unit 103 determines an insertion position of the target piece of additional information based on the insertion priority of the piece of additional information (S104).

Then, the additional information insertion position determination unit 103 controls the display unit 104 to insert the piece of additional information to the determined insertion position.

More specifically, the display unit 104 displays a piece of additional information having a higher (greater) calculated insertion priority on a position receiving more attention from the user. More specifically, the display unit 104 displays a piece of additional information having a higher (greater) calculated insertion priority at a position closer to the center of the screen of the display unit 104 in a region for displaying the piece of additional information.

The following described each of the steps in the display control processing in more detail with reference to the drawings.

First, the display screen of the display unit 104 is described.

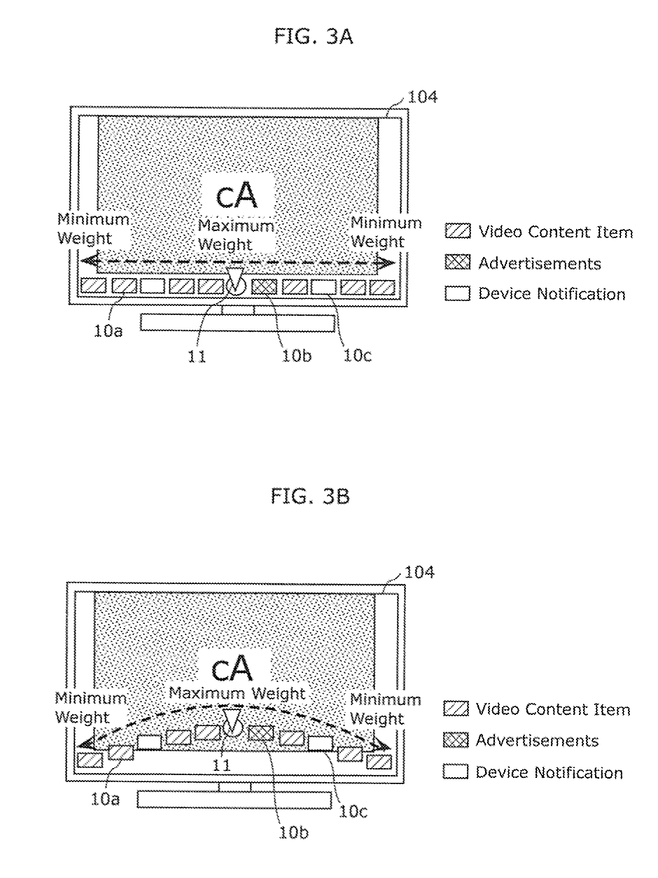

FIG. 3A is a diagram for explaining an example of information presentation according to Embodiment 1.

FIG. 3A shows that the display unit 104 displays a main content item cA and a plurality of thumbnail images. The plurality of thumbnail images form a chain arranged in a straight line in a lateral direction of the screen of the display unit 104. In FIG. 3A, at the center of the chain including the thumbnail images is pointed by an arrow 11.

Here, regarding the thumbnail images, a piece of additional information is inserted at a position (insertion position) between two neighbor thumbnail images which is determined at Step S104. In other words, an insertion position between thumbnail images forming a chain is a region for displaying a piece of additional information.

Hereinafter, a sub region for displaying pieces of additional information is referred to also as an additional information display region, the additional information display region is at least at part of in the screen of the display unit 104. For example, the additional information display region is a chain region including the thumbnail images forming a chain. It should be noted that the additional information display region is not limited to the above-described region, but may have a different shape.

In the additional information display region, a position closer to the center of the screen of the display unit 104 receives more attention from the user. Therefore, in the additional information display region, a position that is the closest to the center of the screen is weighted at maximum, and a position farther away from the center of the screen is less weighted.

A thumbnail image 10a is a thumbnail image of a video content item. A thumbnail image 10b is a thumbnail image indicating a piece of additional information belonging to the advertisement category. A thumbnail image 10c is a thumbnail image indicating a piece of additional information belonging to the device notification category.

Each of the thumbnail images moves to a different position when the user performs a switching operation by using a remote controller. A video content item corresponding to a thumbnail image moved to the position pointed by the arrow 11 is displayed as a large size image, such as the main content item cA, which occupies the most of the screen. The thumbnail image moved to the position pointed by the arrow 11 is changed to a circular image overlapping the arrow 11. It is also possible that the thumbnail image moved to the arrow 11 is not displayed.

It should be noted that the thumbnail images may be arranged in an arc as shown in FIG. 3B.

It should also be noted that the thumbnail images and the pieces of additional information which are arranged in a straight line in FIG. 3A and the thumbnail images and the pieces of additional information which are arranged in an arc in FIG. 3B may be a part of thumbnail images and pieces of additional information which correspond to content items received by the display control device 1000. In this case, it is possible that a new thumbnail image and a new piece of additional information are displayed on the additional information display region by a user's switching operation.

Next, the display screen of the display unit 104 in the case where display is switched by a user's switching operation. In other words, the description is given for an image which is displayed in the main region, and thumbnail images and pieces of additional information which are displayed in the additional information display region.

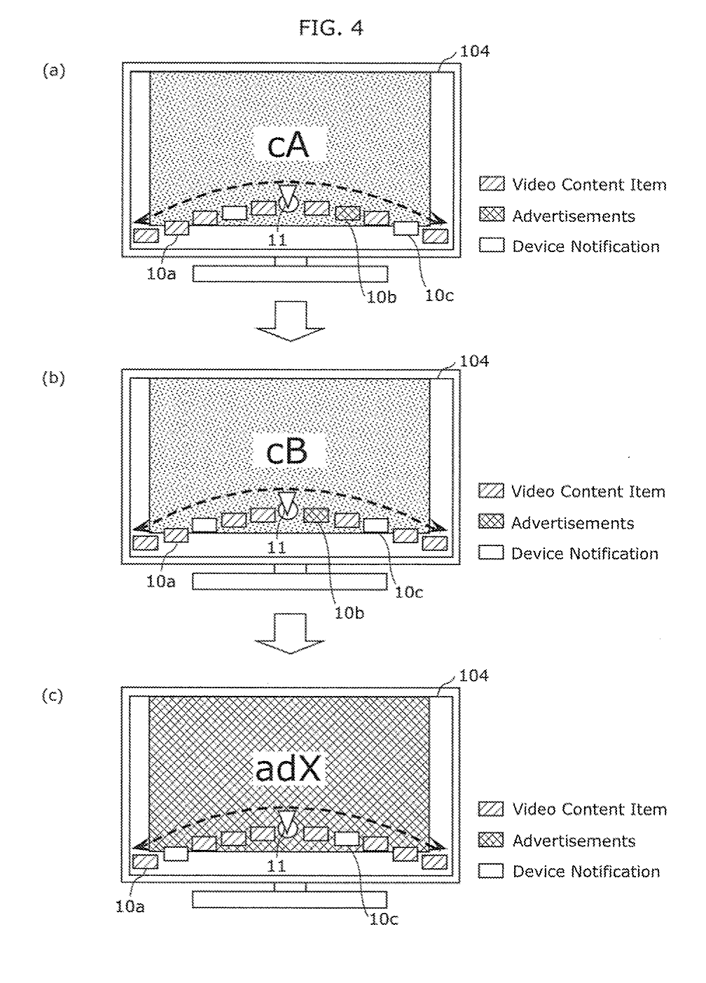

FIG. 4 is a diagram for explaining a move of each thumbnail image.

FIG. 4 (a) shows that a video content item corresponding to a thumbnail image moved to the position pointed by the arrow 11 is displayed as the main content item cA.

Here, for example, it is assumed that the user uses a remote controller to perform a switching operation to switch a current main content item to another. The switching operation is, for example, an operation for moving each of the thumbnail images to a next position on the left.

In this case, the display control device 1000 controls the display unit 104 to move each of the thumbnail images to a next position on the left.

As a result, as shown in FIG. 4 (b), each of the thumbnail images is moved to a next position on the left. In this case, a video content item corresponding to a thumbnail image moved to the position pointed by the arrow 11 is displayed as a main content item cB instead of the main content item cA. In short, the main content item is switched to another. In other words, the thumbnail images are images from which a main content item is selected.

Furthermore, it is assumed that, in the state shown in FIG. 4 (b), the user uses a remote controller to perform a switching operation to move each of the thumbnail images to a next position on the left. In this case, the display control device 1000 performs the same processing as described previously.

As a result, as shown in FIG. 4 (c), each of the thumbnail images is moved to a next position on the left. In this case, a thumbnail image 10b moved to the position pointed by the arrow 11 may be displayed as a main content item adX having a large size occupying the most of the screen, in the same manner as described for the video content item.

In this case, a piece of additional information indicated by the thumbnail image 10b is selected by the switching operation.

The main content item adX is, for example, video of advertisement (commercial message). It should be noted that the main content item adX is not limited to video, but may be any image of advertisement information.

As described above, the display control device 1000 can switch a main content item to another according to instructions from the user. More specifically, from among the display elements corresponding to respect video content items and the pieces of additional information, the user can switch a main content item to another, without a conscious of differences of types of broadcast, broadcast content items, web content items, and pieces of additional information obtained from different electrical devices 301. In other words, the user can seamlessly select (zap) one of the video content items and the pieces of additional information. Therefore, the display control device 1000 can provide a continuity in user's processing for selecting a target from among the video content items and the pieces of additional information.

Furthermore, the display unit 104 displays a chain including a plurality of thumbnail images (content items). Therefore, the user can learn what kinds of content items are arranged before and after the currently-watching main content item. As a result, it is possible not only to perform zapping to a next position, but also to directly select a desired content.

Next, the processing for determining an insertion position of a piece of additional information is described. The description is given for the situation where pieces of additional information belonging to respective two different categories are inserted to positions between thumbnail images.

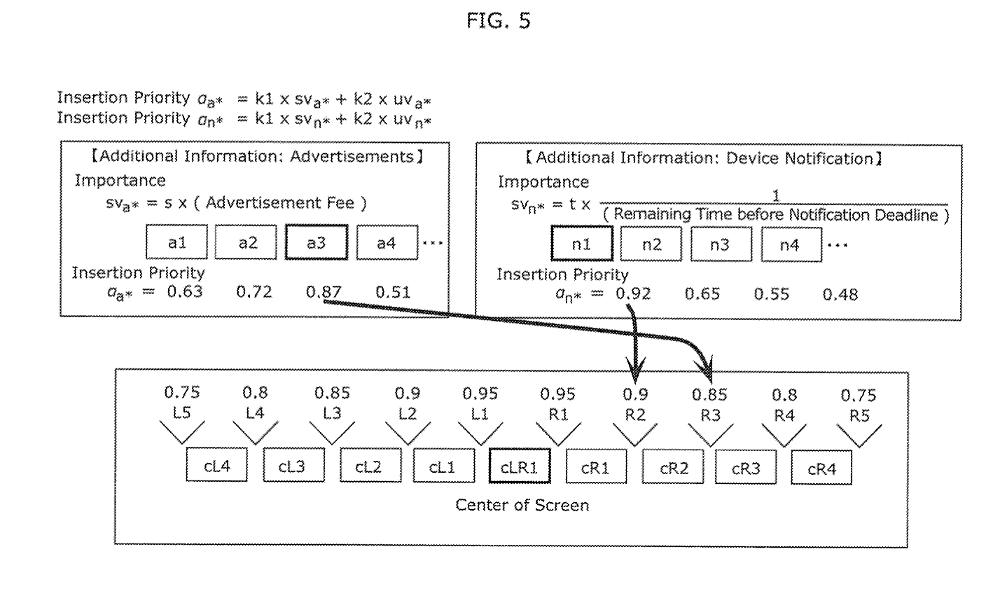

FIG. 5 is a diagram for explaining the processing performed by the additional information insertion position determination unit 103 at the step (S104) for determining an insertion position of the display control processing shown in FIG. 2.

In FIG. 5, cLR1 represents, for example, a main content item displayed in the same manner as the main content item cA shown in FIG. 3A. The main content item is, for example, a video content item such as a broadcast content item, a VOD content item, or a Web video content item. cL4, cL3, cL2, cL1, cR1, cR2, cR3, and cR4 are, for example, thumbnail images displayed in the same manner as shown in FIG. 3A.

In other words, a content item corresponding to cLR1 is displayed as a main content item in the main region, and the content items corresponding to respective ones except cLR1 are displayed as thumbnail images in the additional information display region.

a1 to a4 and n1 to n4 are pieces of additional information, a1 to a4 belong to a category different from a category to which n1 to n4 belong. More specifically, a1, a2, a3, and a4 are pieces of additional information belonging to the advertisement category. n1, n2, n3, and n4 are pieces of additional information belonging to the device notification category.

L5, L4, L3, L2, L1, R1, R2, R3, R4, and R5 are position coefficients each corresponding to a corresponding one of the insertion positions of the pieces of additional information. Each of the pieces of additional information is inserted in an insertion position having a position coefficient that is the closet to an insertion priority of the piece of additional information. For example, the position coefficient L2 is a position coefficient for inserting a corresponding piece of additional information between the thumbnail image cL2 and the thumbnail image cL1.

Device notification n1 is, for example, a message “Power Consumption at home nearly excesses a target value.” Device notification n2 is, for example, a message “Power consumption in Eco City nearly excesses a target value. Please save energy.” Device notification n3 is, for example, a message “Light is On in the bedroom on the second floor while no one is there.” Device notification n4 is, for example, a message “Washing and drying are completed.”

Next, (i) the pieces of additional information belonging to the advertisement category and (ii) the processing for determining an insertion position of a piece of additional information belonging to the device notification category, which are shown in FIG. 5, are sequentially described.

(i) In the case of the advertisement category,

the importance calculation unit 101 calculates an importance of a piece of additional information so that the importance is greater (higher) as an advertisement fee is higher.

In the following description, a piece of additional information belonging to the advertisement category is referred to also as advertisement a* (*=1, 2, 3, 4, 5, . . . ). Here, an advertisement fee for the advertisement a* is assumed to m_{a*}. In this case, an importance sv_{a*} of the piece of additional information belonging to the advertisement category is expressed by the following Equation 1.

[Math. 1]

sv_{a*}=s×m_{a*} (Equation 1)

where S is a predetermined value.

Next, a method of calculating an insertion priority a, of the advertisement a* is described.

Here, uv_{a*} represents a relevance between the advertisement a* and a main content item. In this case, the insertion priority α_{a*} is determined by the additional information insertion position determination unit 103 according to the following Equation 2 (S103),

[Math. 2]

α_{a*}=k1×sv_{a*}+k2×uv_{a*} (Equation 2)

where k1 is a predetermined coefficient and k2 is another predetermined coefficient.

The relevance uv_{a*} is calculated by the relevance calculation unit 102 (S102). The relevance uv_{a*} indicates a similarity between the piece of additional information and the main content item. As described above, the relevance calculation unit 102 calculates, as the relevance uv_{a*}, for example, a similarity between meta data of the main content item and meta data of the piece of additional information belonging to the advertisement category.

It should be noted that the relevance uv_{a*} may be a value predetermined for each of the categories for main content items.

As shown in FIG. 5, a pre-weighted value is set for each of the position coefficients L5, L4, L3, L2, L1, R1, R2, R3, R4, and R5. For the position coefficients L5, L4, L3, L2, L1, R1, R2, R3, R4, and R5, in the region for displaying pieces of additional information, a position closer to the center of the screen of the display unit 104 is heavily weighted (has a greater value) (see FIG. 3A). These weights are, for example, set to L5=0.75, L4=0.8, L3=0.85, L2=0.9, L1=0.95, R1=0.95, R2=0.9, R3=0.85, R4=0.8, and R5=0.75.

Then, the additional information insertion position determination unit 103 controls the display unit 104 to insert a piece of additional information, which has an insertion priority with a value that is the closet to a weight (value) of a corresponding position coefficient, to an insertion position corresponding to the position coefficient.

In the example of FIG. 5, to an insertion position corresponding to the position coefficient R3 indicating 0.85, a piece of additional information (advertisement a3) having an insertion priority of 0.87 is inserted by the additional information insertion position determination unit 103.

(ii) In the case of the device notification category,

the importance calculation unit 101 calculates an importance of a piece of additional information so that an importance is greater (higher) as a time duration (remaining time) from a current time to a notification deadline of the piece of additional information is shorter. The notification deadline is a notification limit predetermined for the piece of additional information.

Hereinafter, a piece of additional information belonging to the device notification category is referred to also as advertisement n* (*=1, 2, 3, 4, 5, . . . ).

Here, td_{n*}is a remaining time from a current time to the notification deadline. In this case, an importance sv_{n*} of the piece of additional information belonging to the device notification category is expressed by the following Equation 3.

$$\begin{matrix}[ Math . 3 ] & \\ {sv}_{{n}^{*}} = t \times \frac{1}{{td}_{{n}^{*}}} & ( Equation 3 )\end{matrix}$$

where t is a predetermined value.

Next, a method of calculating an insertion priority α_{n*}of the device notification n* is described.

Here, uv_{n*}represents a relevance between the device notification n* and a main content item. In this case, the insertion priority α_{n*} is determined by the additional information insertion position determination unit 103 according to the following Equation 4 (S103).

[Math. 4]

α_{n*}=k1×sv_{n*}+k2×uv_{n*} (Equation 4)

where k1 is a predetermined coefficient and k2 is another predetermined coefficient.

The relevance uv_{n*} is calculated by the relevance calculation unit 102 (S102). For example, the relevance calculation unit 102 calculates, as the relevance uv_{n*} a similarity between meta data of the main content item and meta data of the piece of additional information belonging to the device notification category. For example, in the case of a piece of additional information corresponding to a microwave, it is possible that a relevance of the piece of additional information is set high if a main content item is a cooking program.

It should be noted that the relevance uv_{n*} may be a value predetermined for each of the categories for main content items, or may be any predetermined value regardless of categories.

In the example of FIG. 5, in the same manner as the previously-described piece of additional information (advertisement a3), to an insertion position corresponding to the position coefficient R2 indicating a weight 0.9, the additional information insertion position determination unit 103 inserts a piece of additional information (device notification n1) having an insertion priority 0.92.

As described above, as described in (i) and (ii), the additional information insertion position determination unit 103 sets a higher insertion priority α_{a*} for an advertisement a* having a higher importance sv_{a*} and a higher relevance uv_{a*}, and sets a higher insertion priority a* for device notification n* having a higher importance sv_{n*} and a higher relevance uv_{n*}, and thereby determines an advertisement a* having a higher calculated insertion priority α_{a*} and device notification n* having a higher calculated insertion priority α_{n*} to positions receiving more attention from the user. More specifically, the additional information insertion position determination unit 103 sets a higher insertion priority for a piece of additional information having a higher importance and a higher relevance, and thereby determines a piece of additional information having a higher calculated insertion priority to a position receiving more attention from the user. In more detail, the additional information insertion position determination unit 103 determines a piece of additional information having a higher calculated insertion priority to a position which is in the additional information display region of the display unit 104 and is closer to the center of the screen of the display unit 104. As a result, the user can easily notice a piece of additional information having a high insertion priority. Therefore, a piece of additional information having a higher insertion priority is determined to be arranged at a position receiving more attention from the user, and the position is in the additional information display region and is the closest to the center of the screen.

It should be noted in the example of FIG. 5 that weights (values) are assigned symmetrically to the position coefficients L5, L4, L3, L2, L1, R1, R2, R3, R4 and R5 corresponding to respective insertion positions of pieces of additional information, but the present disclosure is not limited to the structure. For example, the piece of additional information (advertisement a3) may be inserted to a position corresponding to one of the position coefficients L3 and R3 each of which indicates 0.85. For example, the piece of additional information (device notification n1) may be inserted to a position corresponding to one of the position coefficients L2 and R2 each of which indicates 0.9.

It is also possible that the weights (values) are assigned asymmetrically to the position coefficients L5, L4, L3, L2, L1, R1, R2, R3, R4 and R5. For example, it is assumed that there is a user who often move each of content items (thumbnail images) to a next position on the left, rather than on the right. It is expected that there is a high possibility that such a user pays more attention to insertion positions on the left with respect to the center of the screen of the display unit 104 (namely, positions corresponding to L5, L4, L3, L2 and L1), rather than insertion positions (positions corresponding to R1, R2, R3, R4 and R5). In this case, L5 is weighted more than R5 (in other words, a value of L5 is set to higher than a value of R5), L4 is weighted more than R4 (in other words, a value of L4 is set to higher than a value of R4), L3 is weighted more than R3 (in other words, a value of L3 is set to higher than a value of R3), L2 is weighted more than R2 (in other words, a value of L2 is set to higher than a value of R2), and L1 is weighted more than R1 (in other words, a value of L1 is set to higher than a value of R1).

On the other hand, it is assumed that there is a user who often moves each of content items (thumbnail images) to a next position on the right, rather than on the left. It is expected that there is a high possibility that such a user pays more attention to insertion positions (positions corresponding to R5, R4, R3, R2 and R1) on the right from the center of the screen of the display unit 104, rather than insertion positions corresponding to L1, L2, L3, L4 and L5. In this case, R5 is weighted more than L5 (in other words, a value of R5 is set to higher than a value of L5), R4 is weighted more than L4 (in other words, a value of R4 is set to higher than a value of L4), R3 is weighted more than L3 (in other words, a value of R3 is set to higher than a value of L3), R2 is weighted more than L2 (in other words, a value of R2 is set to higher than a value of L2), and R1 is weighted more than L1 (in other words, a value of R1 is to higher than a value of L1).

It should be noted that the method of calculating an importance of a piece of additional information is not limited to the above. Here, a category of a piece of additional information may be the above-described power consumption (power amount).

Thereby, the user can easily notice a power amount of the electrical device 301. As a result, for example, the user can check a power amount indicated in a piece of additional information and instruct the electrical device to reduce power consumption according to the check result, eventually saving energy.

If a piece of additional information belongs to the power amount category, the importance calculation unit 101 may calculate an importance of the piece of additional information so that the importance is higher as a power amount consumed by the electrical device 301 is closer to a power amount supplied to the electrical device 301.

Thereby, a piece of additional information of the electrical device 301 in which a power consumption is closer to a supplied power amount can be displayed at a position receiving more attention from the user. As a result, the user can easily notice the piece of additional information of the electrical device 301 before a power amount consumed by the electrical device 301 is equal to a supplied power amount. Therefore, the user can instruct the electrical device 301 to lower the power consumption to prevent troubles caused when the power consumption is equal to the supplied power amount.

As described above, the display control device 1000 according to the present embodiment is a display control device that performs processing using a main content item and a plurality of display elements. Here, the main content item is to be displayed by a display unit, and the display elements are arranged in a chain from which the main content item is selected. The display control device 1000 includes the importance calculation unit 101, the relevance calculation unit 102, and the additional information insertion position determination unit 103. The importance calculation unit 101 obtains additional information and calculates an importance of the additional information. Here, the additional information is information to be notified to a user. The relevance calculation unit 102 calculates a relevance between the additional information and the main content item. The additional information insertion position determination unit 103 determines a position based on the importance calculated by the importance calculation unit and the relevance calculated by the relevance calculation unit. Here, the position is a location to which the additional information is to be inserted in the display elements. The additional information insertion position determination unit 103 determines the position to receive more attention from the user as the importance and the relevance of the additional information are higher.

In short, the additional information insertion position determination unit 103 determines a position to which a piece of additional information is to be inserted among the display elements, based on an importance of the piece of additional information and a relevance to the main content item. As a result, it is possible to notify the piece of additional information in consideration of the importance of the piece of additional information and the relevance to the main content item.

Furthermore, the display control device allows the user to seamlessly perform selection and operation of various content items and checking of pieces of additional information (pieces of notification information) without a particular conscious to differences of these various kinds, and easily access a target.

In addition, the user can comprehensively zap pieces of notification from electrical devices, various kinds of advertisements, and the like in addition to AV content items such as broadcast content items and video content items on a Web.

Furthermore, the display control device 1000 according to the present embodiment is capable of setting a piece of additional information having a higher importance to a position receiving more attention from the user. As a result, it is possible to reduce a possibility that the user misses an important piece of additional information.

An example of a category to which a piece of additional information belongs is advertisements. In this case, for example, if a main content item is drama, advertisements regarding a cast in the drama, a product used in the drama, or the like can be displayed as a piece of additional information, thereby increasing an appeal to the user.

If a piece of additional information belongs to the advertisement category, the importance calculation unit 101 calculates an importance of the piece of additional information so that the importance is higher as an advertisement fee indicated by the piece of additional information is higher. As a result, advertisements having a higher advertisement fee can be displayed at a position receiving more attention from the user.

It is assumed that the display control device 1000 communicates with the electrical device 301, and a piece of additional information belongs to a category of notification from, for example, the electrical device 301. In this case, for example, even if a main content item is drama, it is possible to display notification obtained from the electrical device 301. As a result, for example, if the electrical device 301 is a microwave, the user can easily notice a display “Heating is completed” during watching the drama and thereby does not forget to take foods out from the microwave.

If a piece of additional information belongs to the category of notification from the electrical device 301, the importance calculation unit 101 calculates an importance of the piece of additional information so at the importance is higher as a time duration from a current time to a notification deadline of the piece of additional information is shorter.

As a result, a piece of additional information having a shorter notification deadline can be displayed at a position receiving more attention from the user. The notification deadline is, for example, a time until which the device can wait an operation from the user. A shorter notification deadline requires a faster response from the user. In other words, a piece of additional information requiring a faster response from the user is displayed on a position receiving more attention from the user. As a result, it is possible to reduce the possibility that the user misses the piece of additional information.

(Variation of Embodiment 1)

Next, a display control device according to a variation of Embodiment 1 is described. The display control device according to the present variation is almost the same as the display control device 1000 according to Embodiment 1. However, The display control device according to the present variation differs from the display control device 1000 according to Embodiment 1 in that an insertion allowability calculation unit is further included to calculate an insertion allowability that is an allowability of inserting a piece of additional information among display elements based on a past selection frequency of the piece of additional information which is a frequency of selecting the piece of additional information in a switching operation for switching main content items, and that the position determination unit further determines a position to which a piece of additional information is inserted among display elements based on the calculated insertion allowability. The following mainly describes differences from Embodiment 1.

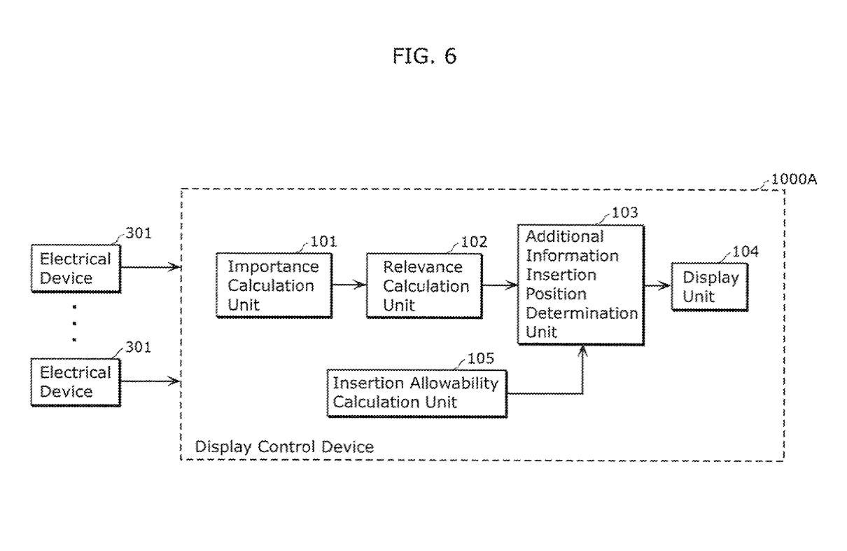

FIG. 6 is a block diagram showing a functional structure of a display control device 1000A according to the variation of Embodiment 1.

As shown in FIG. 6, the display control device 1000A according to the present variation differs from the display control device 1000 shown in FIG. 1 in that an insertion allowability calculation unit 105 is further included. Other structure and functions of the display control device 1000A are the same as those of the display control device 1000, so that they are not described repeatedly in the following description.

The insertion allowability calculation unit 105 calculates an insertion allowability which is described in detail later. The insertion allowability is an allowability of inserting a target piece of additional information from among the plurality of thumbnail images (display elements) forming a chain. The allowability is a degree of user's allowing.

The insertion allowability calculation unit 105 stores past selection frequency for each of the pieces of additional information selected as a main content item in the switching operation. The selection frequency is a count. It should be noted that the selection frequency may be a time of selecting a target piece of additional information as a main content item.

The insertion allowability calculation unit 105 stores a selection frequency of a piece of additional information selected in switching operation, every time the users perform switching operation.

It should be noted that the storing of a selection frequency of each of pieces of additional information may be performed by a different structural element not shown in the figure. In this case, the insertion allowability calculation unit 105 obtains a past selection frequency of each of pieces of additional information from the different structural element.

Next, the processing performed by the display control device 1000A (hereinafter, referred to also as “display control processing A”) is described.

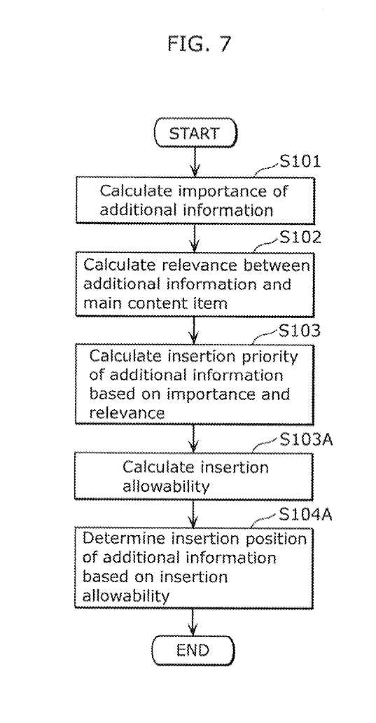

FIG. 7 is a flowchart of the display control processing A. The same step numbers in FIG. 2 according to Embodiment 1 are assigned to the identical steps in FIG. 7, so that the identical steps are not described in detail repeatedly.

First, in the same manner as described in Embodiment 1, the processing from Step S101 to Step S103 is performed. The processing from Step S101 to Step S103 is performed for each of pieces of additional information. Thereby, an insertion priority of each of the pieces of additional information is calculated.

Subsequently, the insertion allowability calculation unit 105 calculates the above-described insertion allowability based on a past selection frequency of a target piece of additional information. More specifically, the insertion allowability calculation unit 105 calculates an insertion allowability having a greater value for a piece of additional information having a higher past selection frequency (S103A). The insertion allowability is a value, for example, ranging from 0 to 1.

Subsequently, the additional information insertion position determination unit 103 determines a position to which the piece of additional information is to be inserted among the display elements (thumbnail images) based on the calculated insertion allowability and the insertion priority of the piece of additional information (S104A). The insertion priority is calculated based on the importance calculated at the importance calculation step (S101) and the relevance calculated at the relevance calculation step (S102). In other words, the additional information insertion position determination unit 103 determines a position to which the piece of additional information is to be inserted among the display elements based on the calculated insertion allowability, the importance, and the relevance.

It should be noted that the step (S104A) for determining an insertion position of a piece of additional information based on an insertion allowability is performed for each of pieces of additional information for which respective insertion allowabilities are calculated.

Then, in the same manner as described in Embodiment 1, the additional information insertion position determination unit 103 controls the display unit 104 to insert the piece of additional information to the determined insertion position.

Next, the description is given for processing for determining insertion positions of pieces of additional information when two different kinds of additional information are to be inserted like the example of FIG. 5.

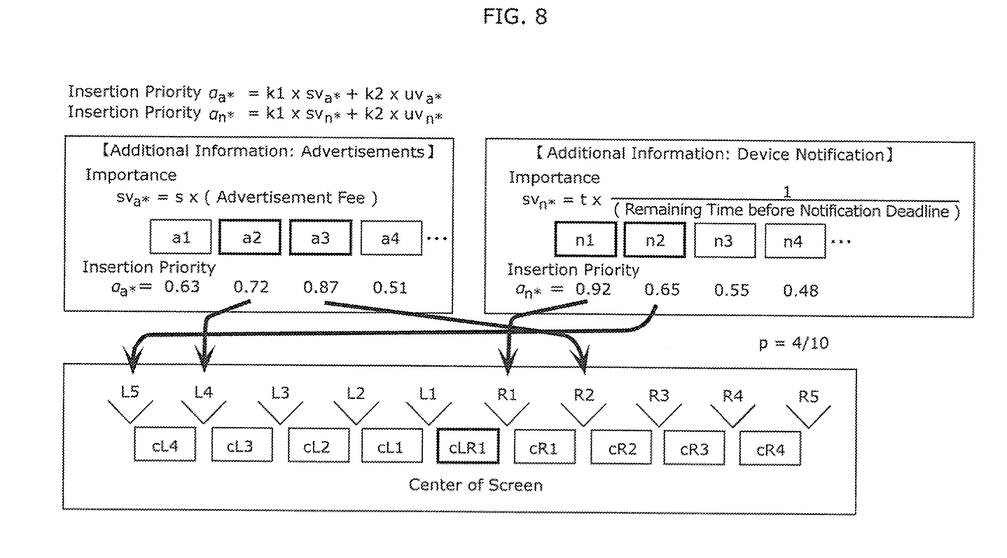

FIG. 8 is a diagram for explaining the step (S104A) for determining insertion positions of pieces of additional information in the display control processing A.

The same reference numerals and characters in FIG. 5 are assigned to the identical elements in FIG. 8, so that the identical elements are not described repeatedly.

In FIG. 8, the method of calculating an importance sv_{a*} of a piece of additional information, an insertion priority oat of advertisement a*, a relevance uv_{a*} an importance sv_{n*} of a piece of additional information, an insertion priority α_{n*} of device notification n*, and a relevance uv_{n*} is the same as described with reference to FIG. 5, so that the method is not explained again.

It is assumed that at the step (S103A) for calculating an insertion allowability, an insertion allowability (p) is calculated as 4/10. In this case, the additional information insertion position determination unit 103 determines four insertion positions from among ten insertion positions corresponding to the position coefficients L1 to L5 and R1 to R5 (S104A). Then, the additional information insertion position determination unit 103 inserts pieces of additional information to the four insertion positions.

More specifically, as shown in FIG. 8, the additional information insertion position determination unit 103 selects four pieces of additional information n1, a3, a2 and n2, in an order of higher insertion priorities, from among advertisements a1, a2, a3, a4, . . . and device notification n1, n2, n3, n4, . . . . Then, the additional information insertion position determination unit 103 inserts the selected n1, a3, a2 and n2 to the insertion positions.

In this case, at least one of L5 and R5 is set to a position from among the position coefficients L5, L4, L3, L2, L1, R1, R2, R3, R4 and R5. L5 or R5 has a value that is normalized to be closer to an insertion priority of 0.65 of n2 which is the lowest insertion priority among those of the selected n1, a3, a2 and n2. In other words, L5 or R5 is set to 0.65. As a result, L5 or R5 is more weighted (assigned with a greater value), as the position coefficient corresponding to the insertion position is closer to the center of the screen.

Then, in the same manner as described in Embodiment 1, the additional information insertion position determination unit 103 controls the display unit 104 to insert a piece of additional information having an insertion priority that is the closest to a weight (value) of each of the position coefficients, to an insertion position corresponding to the corresponding position coefficient.

As described above, the display control device 1000A according to the present variation differs from the display control device 1000 according to Embodiment 1 in that an insertion allowability calculation unit 105 is further included to calculate an insertion allowability that is an allowability of inserting a piece of additional information among display elements based on a past selection frequency of the piece of additional information which is a past frequency of selecting the piece of additional information in a switching operation for switching main content items, and that the position determination unit 103 further determines a position to which the piece of additional information is inserted among display elements based on the calculated insertion allowability.

Therefore, it is possible to perform adjustment according to user's preference. For example, it is possible to increase or decrease the number of pieces of additional information inserted among display elements based on a user's past selection frequency.

(Other Variations)

As described above, although display control devices according to the embodiment and its variation are described, the present discloser is not limited to any one of the embodiment and the variation. Those skilled in the art will be readily appreciated that various modifications of the embodiment and the variation and combinations of the structural elements of the embodiment and the variation are possible without materially departing from the novel teachings and advantages of the present disclosure. Accordingly, all such modifications and combinations are intended to be included within the scope of the present disclosure.

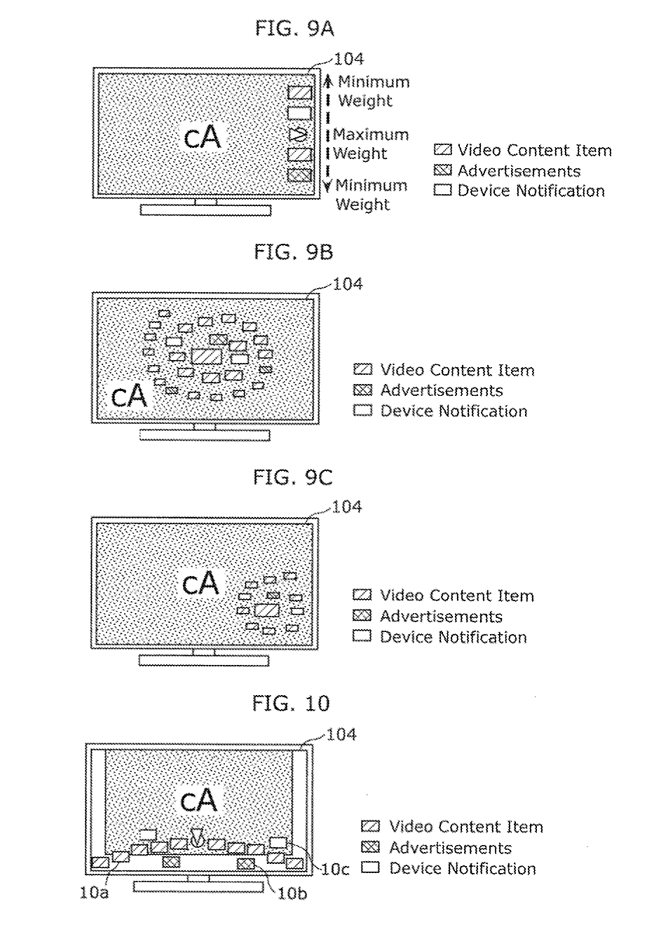

For example, as shown in FIG. 9A, the plurality of thumbnail images may be arranged in a vertical straight line on the screen. In this case, a position that is the closet to the center of the screen in the additional information display region is weighted at maximum, and a position farther away from the center of the screen is less weighted.

As shown in FIGS. 9B and 9C, the thumbnail images may be arranged in a spiral. In this case, a position that is the closet to the center of the spiral is weighted at maximum, and a position farther away from the center of the spiral is less weighted.

In addition, as shown in FIG. 3A described previously, the thumbnail images may be arranged so that a plurality of categories, such as the “video content item” category, the “device notification” category, and the “advertisement” category are arranged in a chain. Furthermore, as shown in FIG. 10, the thumbnail images may be displayed so that different categories are arranged in different chains to distinguish the thumbnail images for each category.

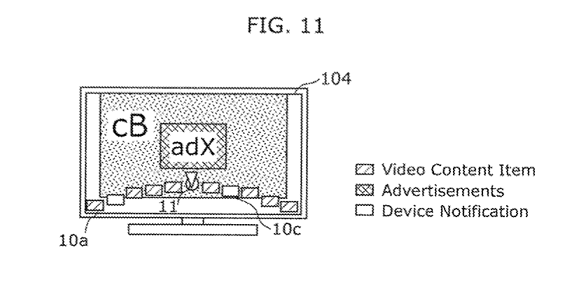

It is also possible in FIG. 4 that the thumbnail image 10b (advertisement) moved to the position pointed by the arrow 11 is reproduced as a pop-up video as shown in FIG. 11, not as a video content item.

Moreover, the display control device 1000 may not include the display unit 104. More specifically, the display control device 1000 may be a device including the importance calculation unit 101, the relevance calculation unit 102, and the additional information insertion position determination unit 103. Likewise, the display control device 1000A may not include the display unit 104.

A piece of additional information may be in association with a recommender who recommends the piece of additional information. In this case, the importance calculation unit 101 may calculate an importance of a piece of additional information so that an importance is higher as a piece of additional information is associated with a recommender in a higher rank order.

More specifically, the importance calculation unit 101 has a recommender rank order list that indicates pieces of information of recommenders and respective rank orders of the recommenders. Furthermore, the importance calculation unit 101 obtains a recommender list that indicates information of a recommender associated with a piece of additional information received by the display control device 1000.

A recommender associated with a piece of additional information is, for example, a viewer who operates to recommend the piece of additional information by using an input device, such as a remote controller, from among viewers watching, on other display control devices, the same piece of additional information as received by the display control device 1000. Therefore, when a viewer recommends a piece of additional information, the viewer is considered as a recommender of the piece of additional information.

The importance calculation unit 101 compares the recommender rank order list with the recommender list to determine whether or not the recommender of the received piece of additional information is included in the recommender rank order list. If the recommender is included in the recommender rank order list, the importance calculation unit 101 determines that a higher importance is to be set for the piece of additional information as the recommender is in a higher rank order. In short, as a recommender is in a higher rank order, the additional information insertion position determination unit 103 calculates a higher insertion priority for a corresponding piece of additional information.

As a result, a piece of additional information associated with a recommender in a higher rank level can be displayed at a position receiving more attention from the user. More specifically, a piece of additional information associated with a recommender in a higher rank level can be displayed at a position that is in a region for displaying pieces of additional information and is closer to the center of the screen of the display unit 104.

Here, a rank order of a recommender may be independent from a corresponding piece of additional information and associated with the display control device 1000, or may be associated with the corresponding piece of additional information as described above.

A rank order of a recommender may be higher as the recommender receives more votes from viewers in a predetermined range.

In this case, a piece of additional information associated with a recommender receiving more votes from viewers in a predetermined range can be displayed at a position receiving more attention from the user. For example, if the predetermined range is a range including viewers having similar preference to user's, a piece of additional information more similar to the user's preference can be displayed at a position receiving more user's attention.

A rank order of a recommender may be predetermined. In other words, a rank order of a recommender may not be updated.

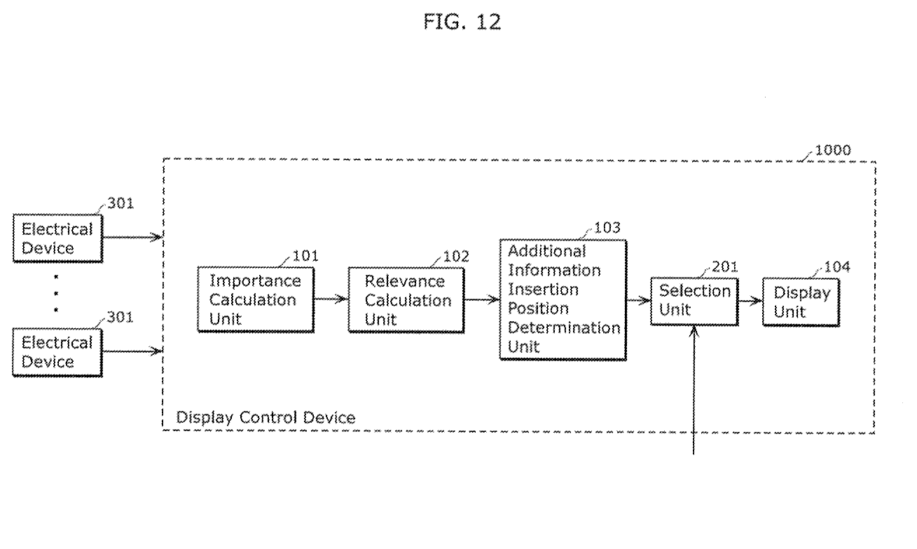

Moreover, the display control device 1000 may further include a selection unit 201 as shown in FIG. 12. The selection unit 201 selects a display element or piece of additional information to be displayed on the main region of the display unit 104 from among a plurality of display elements and pieces of additional information according to user's instructions, and then causes the display unit 104 to display the selected display element or piece of additional information as a main content item.

As a result, it is possible to switch a main content item to another to be displayed by the display unit 104 according to user's instructions. For example, when the selection unit 201 receives an operation using a cross key on a remote controller, a main content item is switched to another according to user's operation inputs of a rightward operator and a leftward operator. On the other hand, for example, when the selection unit 201 receives operations using a jog dial of a remote controller, a main content item is switched to another according to user's rotation operation by the jog dial.

More specifically, the user can seamlessly select a plurality of display elements corresponding to video content items and pieces of additional information, without a conscious of differences among various kinds of broadcasting, broadcast content items, web content items, the pieces of additional information obtained form different electrical devices 301, and the like. In other words, the user can seamlessly select (zap) such video content items and pieces of additional information. That is, the display control device 1000 provides a continuity in user's selection of video content items and pieces of additional information.

In each of the above-described embodiment and variations, each of structural elements may be implemented as a dedicated hardware or executed by a software program suitable for the structural element. Each of the structural elements may be implemented when a program execution unit, such as a Central Processing Unit (CPU) or a processor, reads a software program from a recording medium, such as a hard disk or a semiconductor memory, and then executes the readout software program. The software for implementing the display control devices according to the above-described embodiment and variations is as follows.

This program executes a display control method of performing processing using (a) a main content item to be displayed by the display unit 104 and (b) a plurality of display elements arranged in a chain from which the main content item is selected. The display control method includes a display control method of performing processing using a main content item and a plurality of display elements, the main content item being to be displayed by a display unit, the display elements being arranged in a chain from which the main content item is selected, the display control method comprising: obtaining additional information, and calculating an importance of the additional information, the additional information being information to be notified to a user; calculating a relevance between the additional information and the main content item; and determining a position based on the calculated importance and the calculated relevance, the position being a location to which the additional information is to be inserted in the display elements, wherein in the determining of the position, the position is determined to receive more attention from the user as the importance and the relevance of the additional information are higher.

The following variations are also possible.

(1) The above-described display control device may be, more specifically, a computer system including a microprocessor, a Read Only Memory (ROM), a Random Access Memory (RAM), a hard disk unit, a display unit, a keyboard, a mouse, and the like. Each of the ROM and the hard disk unit holds a computer program. The microprocessor operates according to the computer program to allow the display control device to execute its functions.

Here, each of the computer programs is combinations of a plurality of instruction codes for issuing instructions to the computer to execute predetermined functions. Each of the devices is not limited to the computer system including a microprocessor, a ROM, a RAM, a hard disk unit, a display unit, a keyboard, a mouse, and the like. It may be a computer system including a part of them.

(2) A part or all of the structural elements included in the above-described display control device may be implemented to a single system Large Scale Integration (LSI).

For example, the importance calculation unit 101, the relevance calculation unit 102, and the additional information insertion position determination unit 103 may be implemented to a single integrated circuit.

The system LSI is a multi-functional LSI in which a plurality of structural elements are integrated into a single chip. An example of such a system LSI is a computer system including a microprocessor, a ROM, a Random Access Memory (RAM), and the like. A computer program is recorded on the ROM. The microprocessor operates according to the computer program to allow the system LSI to execute its functions.

Here, the integrated circuit is referred to as a system LSI, but the integrated circuit can be called an IC, a LSI, a super LSI or an ultra LSI depending on their degrees of integration. Note also that the technique of integrated circuit is not limited to the LSI, and it may be implemented as a dedicated circuit or a general-purpose processor. It is also possible to use a Field Programmable Gate Array (FPGA) that can be programmed after manufacturing the LSI, or a reconfigurable processor in which connection and setting of circuit cells inside the LSI can be reconfigured.

Furthermore, if due to the progress of semiconductor technologies or their derivations, new technologies for integrated circuits appear to be replaced with the LSIs, it is, of course, possible to use such technologies to implement the functional blocks as an integrated circuit. For example, biotechnology and the like can be applied to the above implementation.

(3) A part or all of the structural elements included in the above-described display control device may be implemented to an Integrated Circuit (IC) card or a single module that is removable from the display control device. The IC card or the module is a computer system including a microprocessor, a ROM, a RAM, and the like. The IC card or the module may include the above-described multi-functional LSI. The microprocessor operates according to a computer program to allow the IC card or the module to execute its functions. The IC card or the module may have tamper resistance.

(4) The present disclosure may be a method including steps performed by characteristic structural units included in the above-described display control device. The present disclosure may be a computer program causing a computer to execute the method, or digital signals indicating the computer program.

It should also be noted that the present disclosure may be a computer-readable recording medium on which the computer program or the digital signals are recorded. Examples of the computer-readable recording medium are a flexible disk, a hard disk, a Compact Disc (CD)-ROM, a magnetooptic disk (MO), a Digital Versatile Disc (DVD), a DVD-ROM, a DVD-RAM, a BD (Blue-ray® Disc), and a semiconductor memory. The present disclosure may be the computer program or the digital signals recorded on these recording mediums.

It should also be noted in the present disclosure that the computer program or the digital signals may be transmitted via an electric communication line, a wired or wireless communication line, a network represented by the Internet, data broadcasting, and the like.

It should also be noted that the present disclosure may be a computer system including a microprocessor and a memory. The memory may hold the computer program. The microprocessor may operate according to the computer program.

It should also be noted that the program or the digital signals may be recorded onto the recording medium to be transferred, or may be transmitted via a network or the like, so that the program or the digital signals can be executed by a different independent computer system.

(5) The above-described embodiment and variations may be combined.

(6) The above-described display control device may be embedded in a smart television set, a tablet that can reproduce video with 4k2k resolution and 20-inch size, a cradle, or the like. By embedding the display control device according to the present disclosure, smart television sets, tablets, cradles, and the like allow a user to comprehensively zap pieces of notification and operations from a device network group, various kinds of advertisements, and the like in addition to AV content items such as broadcast content items and video content items on a Web.

It should also be noted that the embodiment and variations disclosed above are merely exemplary in every aspect and do not limit the present disclosure. The scope of the present disclosure is indicated not by the above description but by the appended claims. Any modifications in the embodiment and variations are intended to have the same meaning and be included within the scope of the claims.

### INDUSTRIAL APPLICABILITY

The display control device according to an aspect of the present disclosure is useful as a device or the like which provides a user with environments allowing the user to comprehensively zap pieces of notification and operations from a device network group, various kinds of advertisements, and the like in addition to AV content items such as broadcast content items and video content items on a Web.

### REFERENCE SIGNS LIST

10, 10b, 10c thumbnail image
11 arrow
101 importance calculation unit
102 relevance calculation unit
103 additional information insertion position determination unit
104 display unit
105 insertion allowability calculation unit
201 selection unit
301 electrical device
1000, 1000A display control device

1-16. (canceled)

17. A display control device that performs processing using a main content item and a plurality of display elements, the main content item being to be displayed by a display unit, the display elements being arranged in a chain from which the main content item is selected, the display control device comprising:
an importance calculation unit configured to obtain additional information and calculate an importance of the additional information, the additional information being information to be notified to a user;
a relevance calculation unit configured to calculate a relevance between the additional information and the main content item; and
a position determination unit configured to determine a position based on the importance calculated by the importance calculation unit and the relevance calculated by the relevance calculation unit, the position being a location to which the additional information is to be inserted in the display elements,
wherein the position determination unit is configured to determine the position to receive more attention from the user as the importance and the relevance of the additional information are higher.

18. The display control device according to claim 17, further comprising
an insertion allowability calculation unit configured to calculate an insertion allowability based on a past selection frequency of the additional information, the insertion allowability indicating an allowability of inserting the additional information to the display elements, the past selection frequency indicating a frequency of selecting the additional information in a switching operation for switching the main content,
wherein the position determination unit is configured to determine the position to which the additional information is to be inserted in the display elements, based on the insertion allowability calculated by the insertion allowability calculation unit, the importance, and the relevance.

19. The display control device according to claim 17, further comprising
a display unit configured to display the display elements and the additional information inserted at the position determined by the position determination unit,
wherein the position determination unit is configured to calculate an insertion priority to be higher as the importance and the relevance of the additional information are higher, and determine the position to receive more attention from the user as the calculated insertion priority of the additional information is higher.

20. The display control device according to claim 19,
wherein the position determination unit is configured to determine the position to be closer to center of a screen of the display unit as the calculated insertion priority of the additional information is higher, the position being in a region for displaying the additional information in the display unit.

21. The display control device according to claim 17,
wherein a category of the additional information is advertisements.

22. The display control device according to claim 21,
wherein the importance calculation unit is configured to calculate the importance of the additional information to be higher as an advertisement fee of the advertisements is higher.

23. The display control device according to claim 17,
wherein the display control device communicates with an electrical device, and
a category of the additional information is notification from the electrical device.

24. The display control device according to claim 23,
wherein the importance calculation unit is configured to calculate the importance of the additional information to be higher as a time duration from a current time to a notification deadline of the additional information is shorter.

25. The display control device according to claim 17,
wherein the display control device communicates with an electrical device, and
a category of the additional information is a power amount of the electrical device.

26. The display control device according to claim 25,
wherein the importance calculation unit is configured to calculate the importance of the additional information to be higher as a power amount consumed by the electrical device is closer to a power amount supplied to the electrical device.

27. The display control device according to claim 17,
wherein the additional information is associated with a recommender who recommends the additional information, and
the importance calculation unit is configured to calculate the importance of the additional information to be higher as a rank order of the recommender associated with the additional information is higher.

28. The display control device according to claim 27,
wherein the rank order of the recommender is higher as the recommender receives more votes from viewers in a predetermined range.

29. The display control device according to claim 17, further comprising
a selection unit configured to select, according to user's instruction, one from among the display elements and the additional information as the main content item to be displayed by the display unit.

30. An integrated circuit that performs processing using a main content item and a plurality of display elements, the main content item being to be displayed by a display unit, the display elements being arranged in a chain from which the main content item is selected, the display control device comprising:
an importance calculation unit configured to obtain additional information and calculate an importance of the additional information, the additional information being information to be notified to a user;
a relevance calculation unit configured to calculate a relevance between the additional information and the main content item; and
a position determination unit configured to determine a position based on the importance calculated by the importance calculation unit and the relevance calculated by the relevance calculation unit, the position being a location to which the additional information is to be inserted in the display elements,
wherein the position determination unit is configured to determine the position to receive more attention from the user as the importance and the relevance of the additional information are higher.

31. A display control method of performing processing using a main content item and a plurality of display elements, the main content item being to be displayed by a display unit, the display elements being arranged in a chain from which the main content item is selected, the display control method comprising:
obtaining additional information, and calculating an importance of the additional information, the additional information being information to be notified to a user;
calculating a relevance between the additional information and the main content item; and
determining a position based on the calculated importance and the calculated relevance, the position being a location to which the additional information is to be inserted in the display elements,
wherein in the determining of the position, the position is determined to receive more attention from the user as the importance and the relevance of the additional information are higher.

32. A non-transitory computer-readable recording medium for use in a computer, the recording medium having a computer program recorded thereon for causing the computer to execute the display control method according to claim 31.
